(19) United States
(12) Patent Application Publication
(10) Pub. No.: US 2017/0102813 A1
(43) Pub. Date: Apr. 13, 2017

(54) FOLDABLE TOUCH MODULE, FOLDABLE DISPLAY DEVICE AND CONTROL METHOD THEREOF

(71) Applicant: Acer Incorporated, New Taipei City (TW)

(72) Inventor: Jin-Ting KUO, New Taipei City (TW)

(21) Appl. No.: 15/089,318

(22) Filed: Apr. 1, 2016

(30) Foreign Application Priority Data
Oct. 8, 2015 (TW) 104133162

(51) Int. Cl. G06F 3/041; G06F 3/044

(52) U.S. Cl. CPC G06F 3/0416; G06F 3/044; G06F 2203/04102

(57) ABSTRACT

A control method applied to a foldable touch-control module is provided. The control method includes detecting a bending level of at least one foldable part of a foldable substrate; and making each sub-touch-control electrode of at least one tunable touch-control electrode structure provided on at least one foldable part be independently connected to a touch-control-electrode-scanning circuit, a ground terminal, or one of floating terminals corresponding to one of the sub-touch-control electrodes through multiple switch circuits of at least one switch-circuit group. Each switch circuit separately connects to one of the sub-touch-control electrodes. Moreover, the paths between the sub-touch-control electrodes of at least one tunable touch-control electrode structure and the touch-control-electrode-scanning circuit are linked through the corresponding switch circuits.

### CROSS REFERENCE TO RELATED APPLICATIONS

This Application claims priority of Taiwan Patent Application No. 104133162, filed on Oct. 8, 2015, the entirety of which is incorporated by reference herein.

### BACKGROUND OF THE INVENTION

Field of the Invention

The present invention relates to a touch-control module, and in particular to a foldable touch-control module.

Description of the Related Art

In recent days, the technology behind foldable display devices has been developing well, and these display devices which include a touch module are the major focus of the current research. When a typical touch module is utilized with a foldable display device, however, it may cause the touch module to misjudge the touch operation, due largely to the bending motion of the foldable display device.

The cause of the aforementioned misjudgment of the touch operation is that the electrodes of the typical touch module are stretched at the bending point, causing the area of the electrodes, and hence the capacitance of the electrodes, to change. The substrate of a typical touch module is compressed due to the bending motion, causing the dielectric constant of the substrate to change, and at the same time, the compression causes a change in the thickness of the substrate and the capacitance of the electrodes. It can be seen that the bending motion of the foldable display device causes the capacitance of the typical touch module to be different from the expected value, leading to misjudgment of the touch operation, which is due to the change of the capacitance of the electrodes, when the user operates the typical touch module.

### BRIEF SUMMARY OF THE INVENTION

An embodiment of a foldable touch-control module is provided. The foldable touch-control module comprises a foldable substrate, at least one tunable touch-control electrode structure, and at least one switch-circuit group. The foldable substrate includes at least one foldable part. At least one tunable touch-control electrode structure is provided on at least one foldable part and includes multiple sub-touch-control electrodes. While at least one switch-circuit group connects at least one tunable touch-control electrode structure and includes multiple switch circuits. Each switch circuit separately connects to one of the sub-touch-control electrodes of at least one tunable touch-control electrode structure. Each sub-touch-control electrode of at least one tunable touch-control electrode structure is independently connected to a touch-control-electrode-scanning circuit, a ground terminal, or one of floating terminals corresponding to one of the sub-touch-control electrodes through at least one switch-circuit group according to a bending level of at least one foldable part. Moreover, the paths between the sub-touch-control electrodes of at least one tunable touch-control electrode structure and the touch-control-electrode-scanning circuit are linked through the corresponding switch circuits.

An embodiment of a foldable display device is provided. The foldable display device comprises a foldable display panel and the foldable touch-control module described above. The foldable touch-control module is provided on the foldable display panel.

An embodiment of a control method applied to a foldable touch-control module is provided. The control method comprises detecting a bending level of at least one foldable part of a foldable substrate; and making each sub-touch-control electrode of at least one tunable touch-control electrode structure provided on at least one foldable part be independently connected to a touch-control-electrode-scanning circuit, a ground terminal, or one of floating terminals corresponding to one of the sub-touch-control electrodes through multiple switch circuits of at least one switch-circuit group. Each switch circuit separately connects to one of the sub-touch-control electrodes, and the paths between the sub-touch-control electrodes of at least one tunable touch-control electrode structure and the touch-control-electrode-scanning circuit are linked through the corresponding switch circuits.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a foldable touch-control module according to an exemplary embodiment;

FIG. 2A is a schematic diagram of a foldable touch-control module without being bent according to an exemplary embodiment;

FIG. 2B is a schematic diagram of the operation of a foldable touch-control module without being bent according to an exemplary embodiment;

FIG. 3A is a schematic diagram of a foldable touch-control module which is bent according to an exemplary embodiment;

FIG. 3B is a schematic diagram of an operation of a foldable touch-control module which is bent according to an exemplary embodiment;

FIG. 4A is a schematic diagram of a foldable touch-control module which is bent according to an exemplary embodiment;

FIG. 4B is a schematic diagram of an operation of a foldable touch-control module which is bent according to an exemplary embodiment;

FIGS. 5A to 5D are schematic diagrams of the sub-touch-control electrodes of a foldable touch-control module according to an exemplary embodiment;

FIG. 6 is a schematic diagram of a foldable electronic device according to an exemplary embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

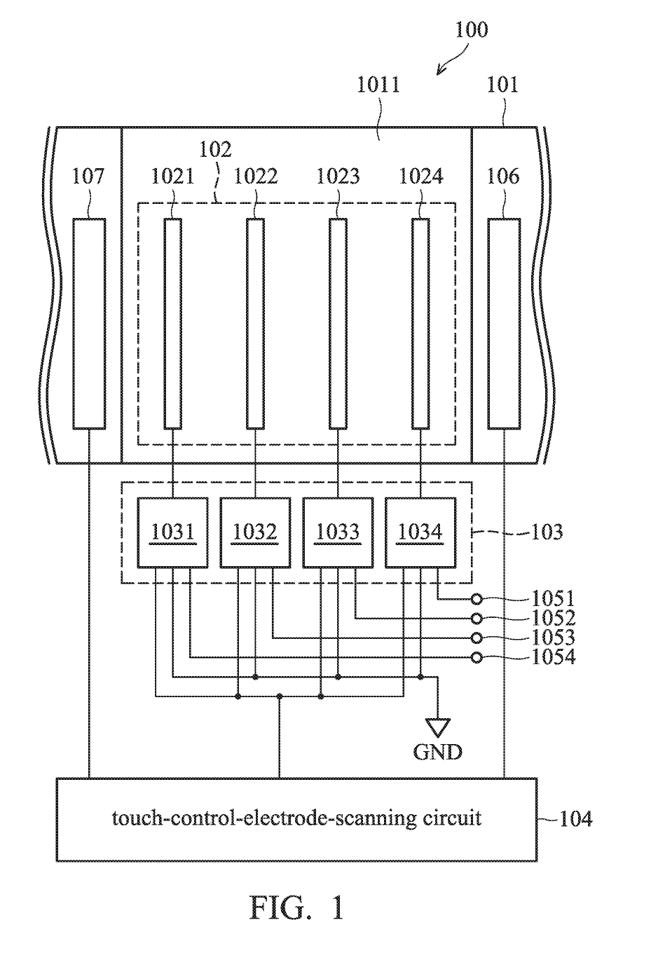

FIG. 1 is a schematic diagram of a foldable touch-control module 100 according to an exemplary embodiment. The foldable touch-control module 100 comprises a foldable substrate 101, a tunable touch-control electrode structure 102, a switch-circuit group 103, typical electrodes 106 and 107, a touch-control-electrode-scanning circuit 104, a ground terminal GND and floating terminals 1051-1054. The foldable substrate 101 includes a foldable part 1011. The tunable touch-control electrode structure 102 is provided on the foldable part 1011, and the tunable touch-control electrode structure 102 includes multiple sub-touch-control electrodes 1021-1024. The switch-circuit group 103 connects the tunable touch-control electrode structure 102 and includes multiple switch circuits 1031-1034. Each switch circuit of the switch circuits 1031-1034 respectively connects the corresponding sub-touch-control electrode of sub-touch-control electrodes 1021-1024, and each floating terminal of the floating terminals 1054-1051 is respectively connected to the corresponding switch circuit of switch circuits 1031-1034, as depicted in FIG. 1. The paths between the sub-touch-control electrodes 1021-1024 and the touch-control-electrode-scanning circuit 104 are linked through the corresponding switch circuits 1031-1034.

In this embodiment, the switch circuits 1031-1034 of the switch-circuit group 103 selectively and respectively connects the sub-touch-control electrodes 1021-1024 with the touch-control-electrode-scanning circuit 104, the ground terminal GND, or the floating terminals 1054-1051 which respectively correspond to the sub-touch-control electrodes 1024-1021 according to a bending level of the foldable part 1011. The switch-circuit group 103 modifies the change of capacitance generated from the bend of the foldable part 1011 in order to prevent the misjudge of the touch control operation. In some embodiments, the sub-touch-control electrodes 1021-1024 of the tunable touch-control electrode structure 102 are all connected to the touch-control-electrode-scanning circuit 104, in this condition, if some sub-touch-control electrodes of the sub-touch-control electrodes 1021-1024 are modified to be connected to the corresponding floating terminals, the total capacitance of the tunable touch-control electrode structure 102 can be reduced. Furthermore, if the sub-touch-control electrodes are further modified to be connected to the ground terminal GND rather than the corresponding floating terminals, the total capacitance of the tunable touch-control electrode structure 102 can be reduced further.

In some embodiments, the material of the sub-touch-control electrodes 1021-1024 can be, but is not limited to, Indium Tin Oxide, copper, silver, carbon nanotube or aluminum.

In some embodiments, the foldable touch-control module 100 further comprises a sensing circuit and a control circuit (which are not shown in FIG. 1). The sensing circuit is coupled to the control circuit, and the sensing circuit can output a detection result to the control circuit based on a bending level of the foldable part 1011. The control circuit controls the switch-circuit group 103 according to the detection result, and the switch-circuit group 103 selectively and respectively connects the sub-touch-control electrodes 1021 to 1024 with the touch-control-electrode-scanning circuit 104, the ground terminal GND or the floating terminals 1054-1051 corresponding to the sub-touch-control electrodes 1024-1021, respectively. In some embodiments, the sensing circuit detects a stress change of the foldable substrate 101 generated from the bend of the foldable part 1011, and generates the detection result according to the stress change, while the present disclosure is not limited by the above description.

In some embodiments, the foldable substrate 101 includes multiple foldable parts which are similar to the foldable part 1011, and each foldable part includes a tunable touch-control electrode structure that is similar to the tunable touch-control electrode structure 102. Each tunable touch-control electrode structure described above respectively connects a corresponding switch-circuit group which is similar to the switch-circuit group 103, and the switch circuits of each switch-circuit group described above independently connect the touch-control-electrode-scanning circuit 104, the ground terminal GND or the floating terminals corresponding to the sub-touch-control electrodes. The paths between the sub-touch-control electrodes of the tunable touch-control electrode structure described above and the touch-control-electrode-scanning circuit 104 are linked through the switch circuits mentioned above, and each switch circuit corresponds to one of the sub-touch-control electrodes.

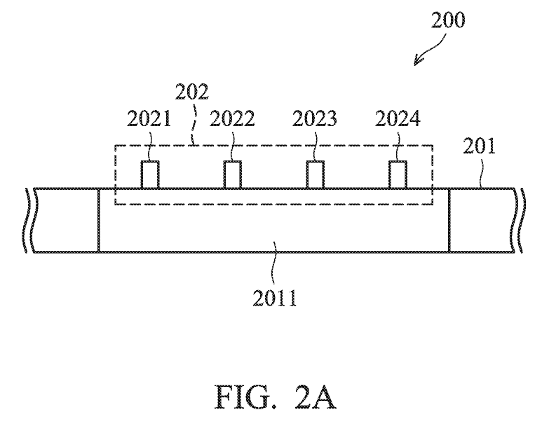

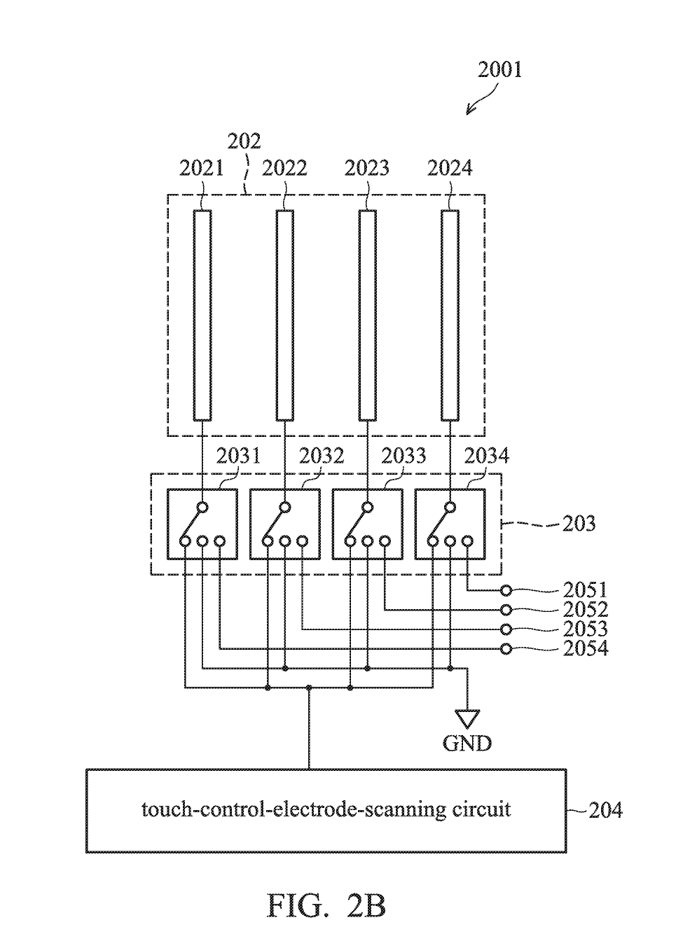

FIG. 2A is a schematic diagram 200 of a foldable touch-control module without being bent according to an exemplary embodiment. The schematic diagram 200 shows that a tunable touch-control electrode structure 202 is provided on a foldable part 2011 of a foldable substrate 201, and the tunable touch-control electrode structure 202 includes sub-touch-control electrodes 2021-2024. As depicted in FIG. 2A, the foldable part 2011 of the foldable substrate 201 is not bent, and the operation corresponding to the foldable touch-control module of this embodiment is shown in schematic diagram 2001 of FIG. 2B.

In this embodiment, the foldable part 2011 of the foldable substrate 201 is not bent, so the sub-touch-control electrodes 2021-2024 are not stretched. Additionally, the foldable part 2011 is not compressed, so the dielectric constant and thickness of the foldable substrate 201 is also unchanged. Based on this situation, the capacitance corresponding to the sub-touch-control electrodes 2021-2024 should match the predetermined values set in the condition that the foldable substrate 201 is not bent. Therefore, switch circuits 2031-2034 of a switch-circuit group 203 connect the sub-touch-control electrodes 2021-2024 to a predetermined path, that is, the switch circuits 2031-2034 of a switch-circuit group 203 connect the sub-touch-control electrodes 2021-2024 with a touch-control-electrode-scanning circuit 204. In some embodiments, the predetermined path might be set to make each of the sub-touch-control electrodes 2021-2024 be respectively connected to the touch-control-electrode-scanning circuit 204, a ground terminal GND or one of the floating terminals 2051-2054.

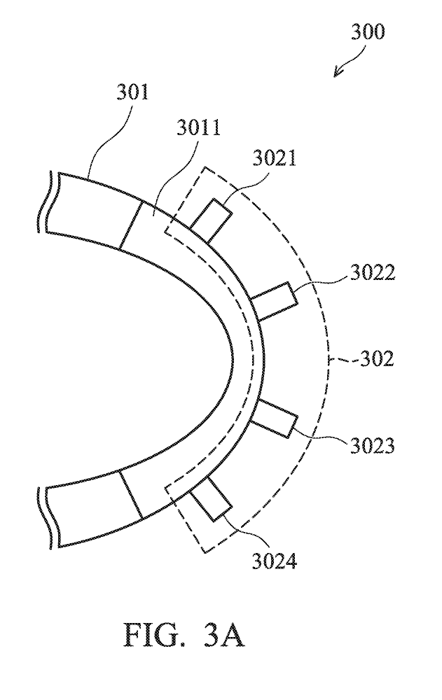

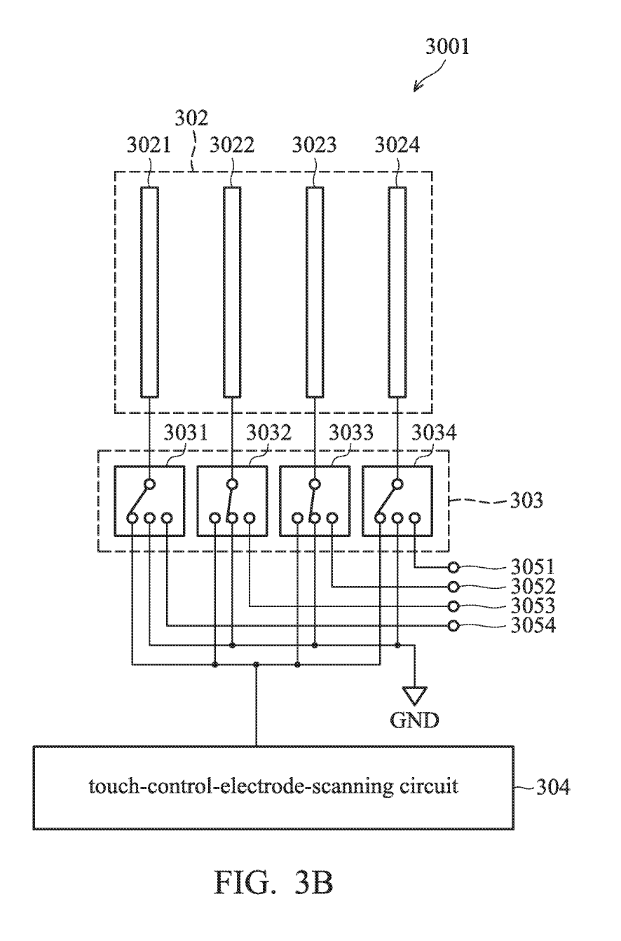

FIG. 3A is a schematic diagram 300 of a foldable touch-control module which is bent according to an exemplary embodiment. The schematic diagram 300 shows that a tunable touch-control electrode structure 302 is provided on a foldable part 3011 of a foldable substrate 301, and the tunable touch-control electrode structure 302 includes sub-touch-control electrodes 3021-3024. As depicted in FIG. 3A, the foldable part 3011 of the foldable substrate 301 is in bend mode, and the operation corresponding to the foldable touch-control module of this embodiment is shown in schematic diagram 3001 of FIG. 3B.

In this embodiment, the foldable part 3011 of the foldable substrate 301 is in bend mode, so the sub-touch-control electrodes 3021-3024 are stretched due to the bending motion. Additionally, the foldable part 3011 is also compressed by the bending motion, so the thickness of the foldable substrate 301 is reduced. Based on this situation, the capacitance corresponding to the sub-touch-control electrodes 3021-024 are greater than the predetermined values set in the condition that the foldable substrate 301 is not bent, which may lead to a misjudgment which relates to a touch control operation.

In this embodiment, switch circuits 3031-3034 of a switch-circuit group 303 change the connection path of the sub-touch-control electrodes 3021-3024 according to a bending level of the foldable part 3011. In this embodiment, the switch-circuit group 303 change the connection of the sub-touch-control electrodes 3021-3024 from a predetermined path, which connects all the sub-touch-control electrodes 3021-3024 to a touch-control-electrode-scanning circuit 304, to be the modified paths. The modified paths are that the sub-touch-control electrodes 3021 and 3024 are connected to the touch-control-electrode-scanning circuit 304, and the sub-touch-control electrodes 3022 and 3023 are connected to a ground terminal GND. The modified paths can reduce the total capacitance corresponding to the tunable touch-control electrode structure 302 which is in bend mode, that is, the operation of FIG. 3B can reduce the capacitance change generated from the bending motion of the tunable touch-control electrode structure 302, and also reduce the probability of misjudgment which relates to the touch control operation.

In some embodiments, the total capacitance change of the tunable touch-control electrode structure 302 corresponding to the bending level of the foldable part 3011 also can be corrected by separately connecting the sub-touch-control electrodes 3021-3024 to the touch-control-electrode-scanning circuit 304, a ground terminal GND, or floating terminals 3054-3051 through the switch circuits 3031-3034 according to the different bending level of the foldable part 3011.

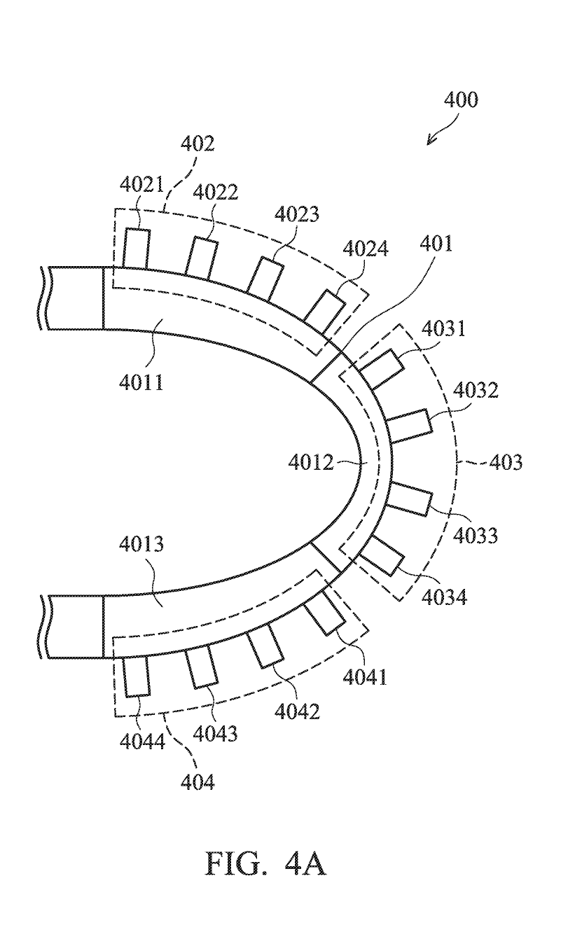

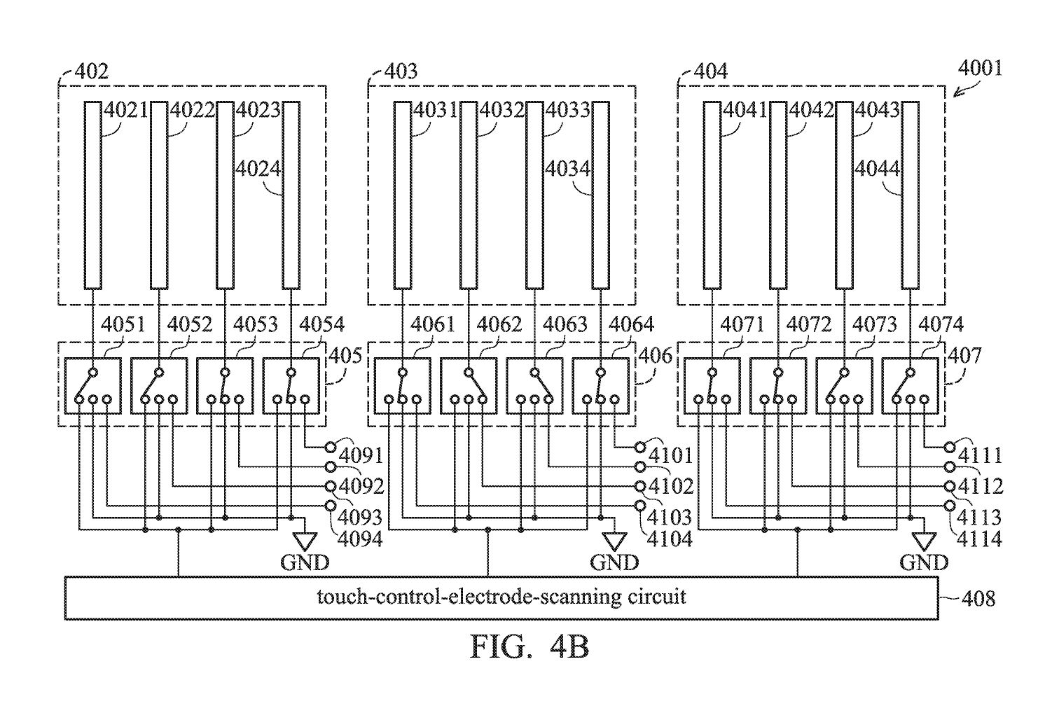

FIG. 4A is a schematic diagram 400 of a foldable touch-control module which is bent according to an exemplary embodiment. The schematic diagram 400 shows that tunable touch-control electrode structures 402-404 are separately and respectively provided on foldable parts 4011-4013 of a foldable substrate 401. The tunable touch-control electrode structures 402-404 include sub-touch-control electrodes 4021-4024, 4031-4034, and 4041-4044, respectively. As depicted in FIG. 4A, the foldable parts 4011-4013 of the foldable substrate 401 have different bending level, and the operation corresponding to the foldable touch-control module of this embodiment is shown in schematic diagram 4001 of FIG. 4B.

In this embodiment, switch circuits 4051-4054, 4061-4064, and 4071-4074 of switch-circuit groups 405-407 change the connection paths of the sub-touch-control electrodes 4021-4024, 4031-4034, and 4041-4044 from a predetermined path, which connects all the sub-touch-control electrodes 4021-4024, 4031-4034, and 4041-4044 to a touch-control-electrode-scanning circuit 408, to the modified paths. The modified paths are set according to the respective bending level of the foldable parts 4011-4013. In this embodiment, a foldable part 4012 has the relatively higher bending level, as shown in FIG. 4A, which makes the relatively higher stretch of the sub-touch-control electrodes 4031-4034 and the relatively larger reduction of the thickness of the foldable part 4012, so the total capacitance of a tunable touch-control electrode structure 403 have the relatively higher increase due to the bending motion in FIG. 4A. On the other hand, the total capacitance increased by the bending motion of the foldable parts 4011 or 4013 are relatively low. In this embodiment, the respective total capacitance increased by the bending motion of the foldable parts 4011 and 4013 are the same, while the present disclosure is not limited by the above description.

In this embodiment, the bending levels of the foldable part 4011 and 4013 are relatively low, so the total capacitance increases of the tunable touch-control electrode structures 402 and 404 are also relatively small. The switch circuits 4051-4054 and 4071-4074 of the switch-circuit groups 405 and 407 connect the sub-touch-control electrodes 4021, 4022, 4043 and 4044 to the touch-control-electrode-scanning circuit 408, and connect the sub-touch-control electrodes 4023, 4024, 4041, and 4042 to a ground terminal GND in order to reduce the capacitance changes generated from the bending motion of the tunable touch-control electrode structures 402 and 404. As show in FIG. 4A, the foldable part 4012 has the relatively higher bending level, so the total capacitance increase of the tunable touch-control electrode structure 403 is relatively high. In this case, the switch circuits 4061-4064 of the switch-circuit group 406 connect the sub-touch-control electrodes 4031 and 4034 to the ground terminal GND, and connect sub-touch-control electrodes 4032 and 4033 to the floating terminals 4103 and 4102, respectively, which further reduces the capacitance change generated from the bending motion of the tunable touch-control electrode structures 403.

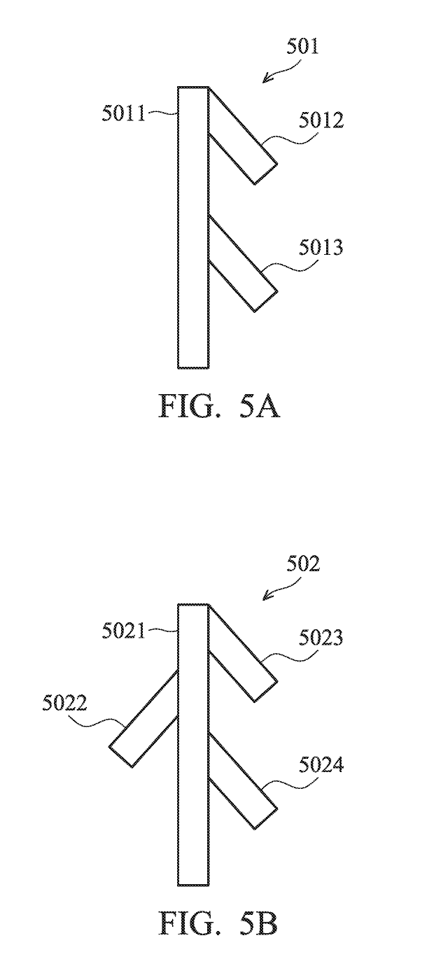

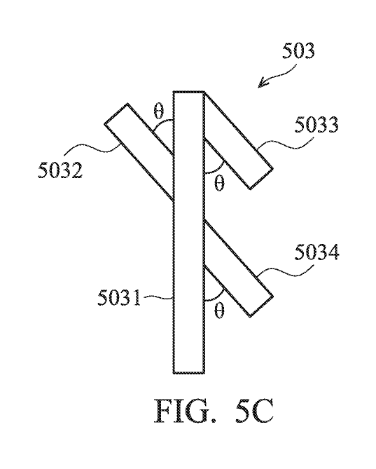

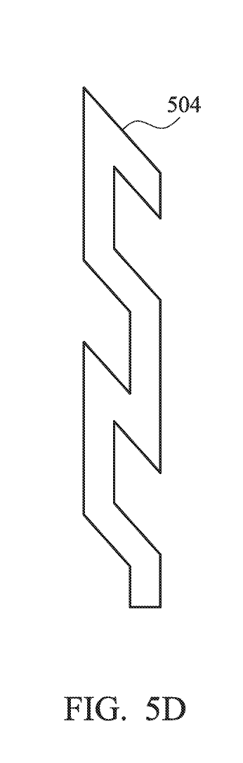

FIGS. 5A to 5D are schematic diagrams of sub-touch-control electrodes of a foldable touch-control module according to an exemplary embodiment. FIG. 5A shows a sub-touch-control electrode 501 of a tunable touch-control electrode structure, comprising a main part 5011 and extension parts 5012 and 5013. FIG. 5B shows a sub-touch-control electrode 502 of a tunable touch-control electrode structure, comprising a main part 5021 and extension parts 5022, 5023 and 5024. The extension part 5022 is provided on one side of the main part 5021, and the extension parts 5023 and 5024 are provided on the other side of the main part 5021. FIG. 5C shows a sub-touch-control electrode 503 of a tunable touch-control electrode structure, comprising a main part 5031 and extension parts 5032, 5033 and 5034. The extension part 5032 is provided on one side of the main part 5031, and the extension parts 5033 and 5034 are provided on the other side of the main part 5031, moreover, all the extension parts 5032, 5033 and 5034 have a predetermined angle θ between the main part 5031. In some embodiments, the predetermined angle θ might be, but is not limited to, 45 degree. FIG. 5D shows a sub-touch-control electrode 504 of a tunable touch-control electrode structure, and the sub-touch-control electrode 504 comprises multiple bent parts.

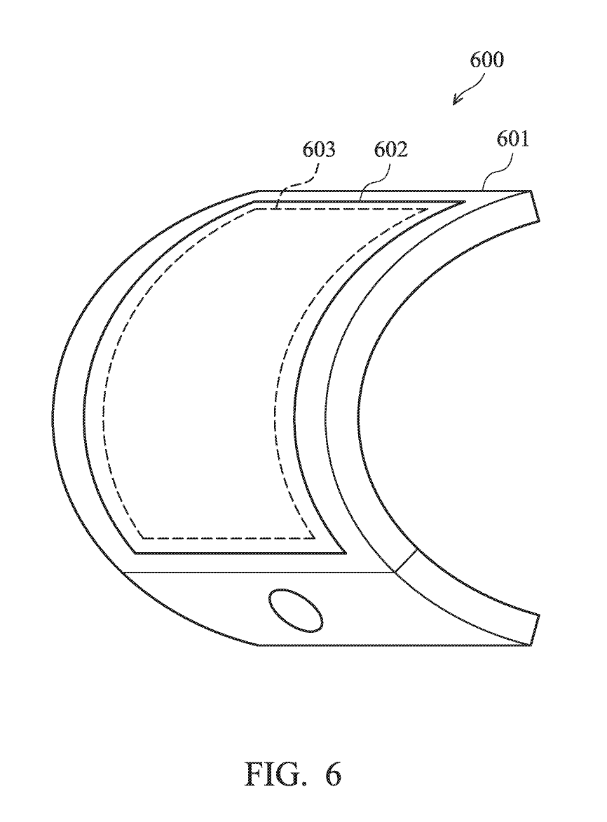

FIG. 6 is a schematic diagram of a foldable electronic device 600 according to an exemplary embodiment. The foldable electronic device 600 comprises a foldable display device 601. The foldable display device 601 includes a foldable display panel 602 and a foldable touch-control module 603 which can be anyone of the foldable touch-control module described above. In this embodiment, the foldable touch-control module 603 is provided on the foldable display panel 602. In some embodiments, the foldable electronics 600 might be, but is not limited to, a smartphone, a TV, a display of a computer, or an electronic book.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A foldable touch-control module, comprising:
a foldable substrate, including at least one foldable part;
at least one tunable touch-control electrode structure which is provided on the at least one foldable part, including multiple sub-touch-control electrodes; and
at least one switch-circuit group, connecting the at least one tunable touch-control electrode structure;
wherein the at least one switch-circuit group includes multiple switch circuits, and each switch circuit respectively connects one of the sub-touch-control electrodes of the at least one tunable touch-control electrode structure;
wherein each sub-touch-control electrode of the at least one tunable touch-control electrode structure is independently connected to a touch-control-electrode-scanning circuit, a ground terminal, or one of floating terminals corresponding to one of the sub-touch-control electrodes through the at least one switch-circuit group according to a bending level of the at least one foldable part;
wherein the paths between the sub-touch-control electrodes of the at least one tunable touch-control electrode structure and the touch-control-electrode-scanning circuit are linked through the corresponding switch circuits.

2. The foldable touch-control module as claimed in claim 1, further comprising:
a sensing circuit, coupled to a control circuit;
wherein the sensing circuit outputs a detection result to the control circuit according to the bending level of the at least one foldable part;
wherein the control circuit controls the at least one switch-circuit group according to the detection result, which makes each sub-touch-control electrode of the at least one tunable touch-control electrode structure be respectively connected to the touch-control-electrode-scanning circuit, the ground terminal, or one of the floating terminals corresponding to one of the sub-touch-control electrodes.

3. The foldable touch-control module as claimed in claim 2, wherein at least one of the sub-touch-control electrodes includes a main part and multiple extension parts.

4. The foldable touch-control module as claimed in claim 2, wherein at least one of the sub-touch-control electrodes includes multiple bent parts.

5. The foldable touch-control module as claimed in claim 3, wherein each extension part has a predetermined angle between the main part.

6. The foldable touch-control module as claimed in claim 1, wherein the material of the sub-touch-control electrodes is Indium Tin Oxide, copper, silver, carbon nanotube or aluminum.

7. The foldable touch-control module as claimed in claim 1, wherein the at least one switch-circuit group connects all the sub-touch-control electrodes of the at least one tunable touch-control electrode structure to the touch-control-electrode-scanning circuit when the at least one foldable part is not bent.

8. A foldable display device comprises:
a foldable display panel; and
the foldable touch-control module of claim 1, provided on the foldable display panel.

9. A control method applied to a foldable touch-control module comprises:
detecting a bending level of at least one foldable part of a foldable substrate; and
making each sub-touch-control electrode of at least one tunable touch-control electrode structure provided on the at least one foldable part be independently connected to a touch-control-electrode-scanning circuit, a ground terminal, or one of floating terminals corresponding to one of the sub-touch-control electrodes through multiple switch circuits of at least one switch-circuit group, and each switch circuit respectively connects one of the sub-touch-control electrodes;
wherein the paths between the sub-touch-control electrodes of the at least one tunable touch-control electrode structure and the touch-control-electrode-scanning circuit are linked through the corresponding switch circuits.

10. The control method as claimed in claim 9 further comprises:
detecting the bending level of the at least one foldable part through a sensing circuit, and then outputting a detection result to a control circuit;
controlling the at least one switch-circuit group through the control circuit according to the detection result; and
making each sub-touch-control electrode of the at least one tunable touch-control electrode structure be respectively connected to the touch-control-electrode-scanning circuit, the ground terminal, or one of the floating terminals corresponding to one of the sub-touch-control electrodes through the at least one switch-circuit group.
